(19) United States
(12) Patent Application Publication
(10) Pub. No.: US 2009/0109272 A1
(43) Pub. Date: Apr. 30, 2009

(54) Printing apparatus

(75) Inventor: Hiroshi Takami, Nagoya-shi (JP)

Correspondence Address: DAY PITNEY LLP, 7 TIMES SQUARE, NEW YORK, NY, 10036-7311, US

(73) Assignee: BROTHER KOGYO KABUSHIKI KAISHA

(21) Appl. No.: 12/288,969

(22) Filed: Oct. 24, 2008

(30) Foreign Application Priority Data
Oct. 26, 2007 (JP) 2007-278724

(51) Int. Cl. B41J 11/00

(52) U.S. Cl. 347/220

(57) ABSTRACT

A printing apparatus includes a case that stores a print medium transferred in the case, a platen roller, a thermal head that is pressed to the platen roller, a radiation member that is made of a metal and is provided on a surface of the thermal head on a reverse face of a pressed face opposing the platen roller, an extended portion that is provided in the radiation member and extended further than the thermal head in a transfer direction of the print medium, and a guide member that is made of a resin to guide the print medium printed by the thermal head and is provided on a surface of the extended portion opposing the platen roller.

### CROSS-REFERENCE TO RELATED APPLICATION

The present application claims priority from Japanese Patent Application No. 2007-278724, which was filed on Oct. 26, 2007, the disclosure of which is herein incorporated by reference in its entirety.

### BACKGROUND

The present disclosure relates generally to technical fields including a printing apparatus capable of performing printing on a print medium.

In the related art, there have been proposed a variety of tape printing apparatuses of the type in which a roll sheet holder with a lengthy roll sheet wound thereon is removably stored. In a tape printing apparatus of this type, the roll sheet wound on the roll sheet holder is drawn out and transferred by the driving of a platen roller, print data such as characters and graphics are printed with a thermal head that is pressed to the platen roller. The printed roll sheet is cut off by a cutting mechanism into a desired length, and the cut-off sheet is discharged from a sheet discharge port to the outside.

As a cutting mechanism, a so-called “guillotine cutter” including a stationary blade and a movable blade is known. The stationary blade is provided along a full width of a width direction on one side of the roll sheet. The movable blade slides relative to the stationary blade and, concurrently, moves along the thickness direction of the roll sheet. In the guillotine cutter, there is a clearance between the thermal head and the cutter. Hence, a guide for guiding the printed roll sheet to the cutter is required so as to prevent a label cut by the guillotine cutter from dropping into the clearance. As a configuration in which the guide such as described above is provided in the vicinity of the thermal head, there is known an image forming apparatus (see Japanese Patent Application Laid-Open Publication No. 2006-347124, for example). In the apparatus, a holder member including a guide portion for guiding an ink sheet that is used for printing is mounted on a backside of a print head via a heat sink. In addition, there is known a stamping apparatus that includes a radiator with a guide plate having a shape which is higher in thickness than the thermal head heating element and low friction (see Japanese Utility Model Application Laid-Open Publication No. HEI 06-79559, for example).

### SUMMARY

However, in the image forming apparatus disclosed in Japanese Patent Application Laid-Open Publication No. 2006-347124, the guide portion is mounted on the back side of the heat sink. Therefore, a variation due to the thickness of the heat sink may occur, resulting in reduction of the correlative positional accuracy between the thermal head and the guide portion. In the stamping apparatus disclosed in Japanese Utility Model Application Laid-Open Publication No. 06-79559, a guide and a metallic radiator plate are formed into an integral unit. Hence, if the metallic guide is damaged, a medium may be damaged by the guide. In the case where the configuration including the integral unit formed from the guide and the metallic radiator plate is applied to a printing apparatus, if the print medium is a thermal paper, the print surface may exhibits color development when it contacts the guide. Further, if the print medium is a copying paper, transfer on the second sheet may occur.

It is one object of the present disclosure to provide a printing apparatus in which the positional accuracy of a guide member in correlation to the thermal head is improved, and a print medium is not damaged and accidental color development, transfer, and the like do not occur even when the print medium contacts with a guide member with damage, if any.

According to first aspect of the present disclosure, there is provided a printing apparatus a case that stores a print medium transferred in the case, a platen roller, a thermal head that is pressed to the platen roller, a radiation member that is made of a metal and is provided on a surface of the thermal head on a reverse face of a pressed face opposing the platen roller, an extended portion that is provided in the radiation member and extended further than the thermal head in a transfer direction of the print medium, and a guide member that is made of a resin to guide the print medium printed by the thermal head and is provided on a surface of the extended portion opposing the platen roller.

### BRIEF DESCRIPTION OF THE DRAWINGS

Exemplary embodiments of the invention will be described below in detail with reference to the accompanying drawings in which:

FIG. 1 is a front perspective view of a tape printing apparatus;

FIG. 2 is a front view of the tape printing apparatus;

FIG. 3 is a rear perspective view of the tape printing apparatus;

FIG. 4 is a perspective view of the tape printing apparatus in the state where a top cover is open;

FIG. 5 is a perspective view of the tape printing apparatus in the state where a roll sheet holder is attached;

FIG. 6 is a vertical cross-sectional view of the tape printing apparatus;

FIG. 7 is an enlarged view of a peripheral portion of a thermal head shown in FIG. 6;

FIG. 8 is a view showing a manner that a roll sheet is guided by a guide member;

FIG. 9 is a view showing a manner that the roll sheet is guided by a modified example of the guide member;

FIG. 10 is a perspective view of a tray base;

FIG. 11 is a left side view of the tray base;

FIG. 12 is a partial enlarged view showing an inner side of an opening portion shown in FIG. 1;

FIG. 13 is a perspective view showing a state where the roll sheet is discharged from a sheet discharge port;

FIG. 14 is a perspective view showing a state where the roll sheet is discharged from the sheet discharge port;

FIG. 15 is a cross-sectional view of a heat transfer label; and

FIG. 16 is a plan view of a base material in which an adhesive layer is provided in an area other than a print range.

### DETAILED DESCRIPTION OF EMBODIMENTS

A tape printing apparatus 1 of one embodiment according to the present disclosure will be described below with reference to the drawings. The tape printing apparatus 1 of the present embodiment stores therein a roll sheet 3A which is a rolled-state print medium, prints characters and graphics etc. on the medium, cuts it off into a desired length, and discharges the cut off sheet.

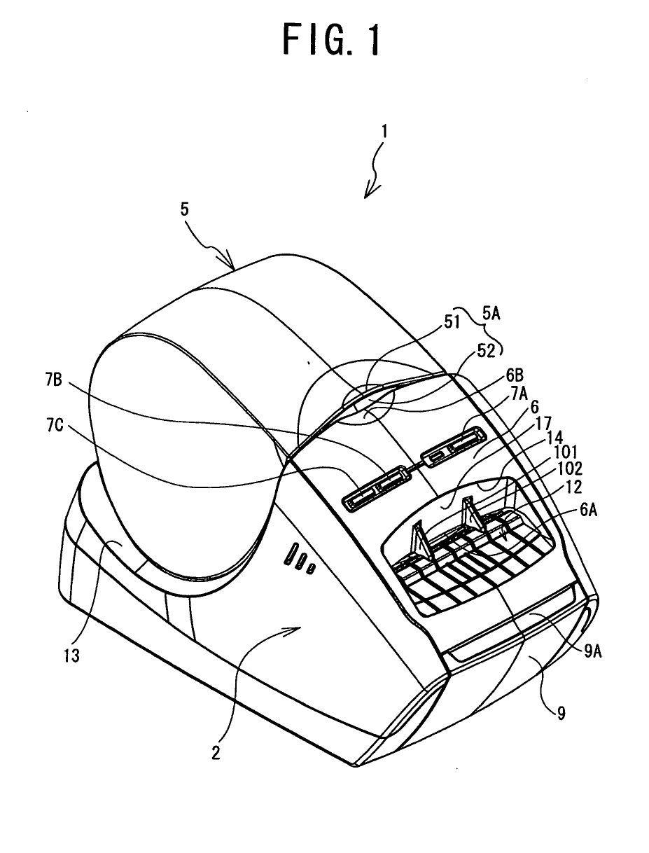

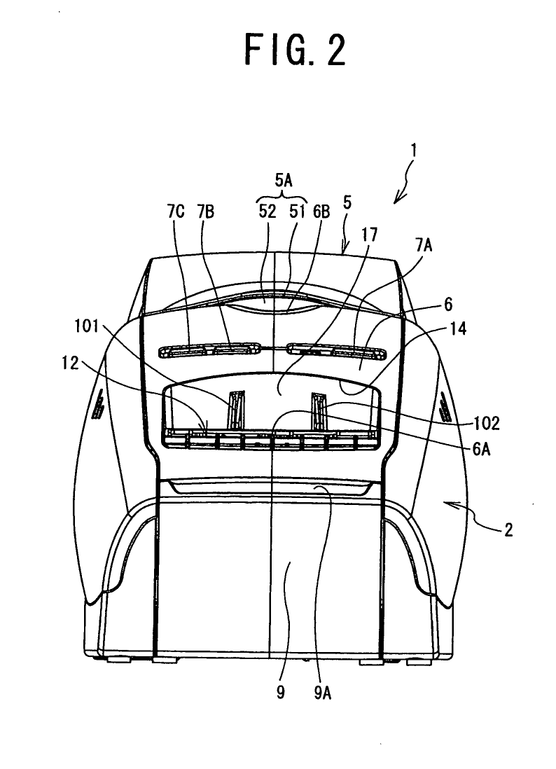

First, a general configuration of the tape printing apparatus 1 will be described with reference to FIGS. 1 to 7. It is assumed that, the righthand, lefthand, bottom, and upper (depth) sides of FIG. 2 respectively correspond to the righthand, lefthand, front, and rear sides of the tape printing apparatus 1.

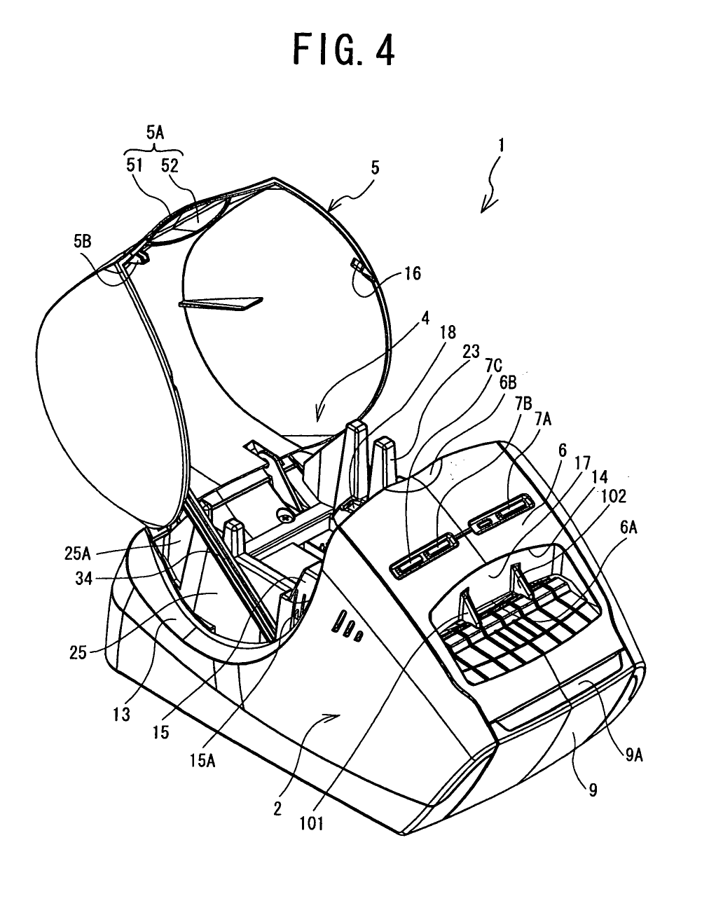

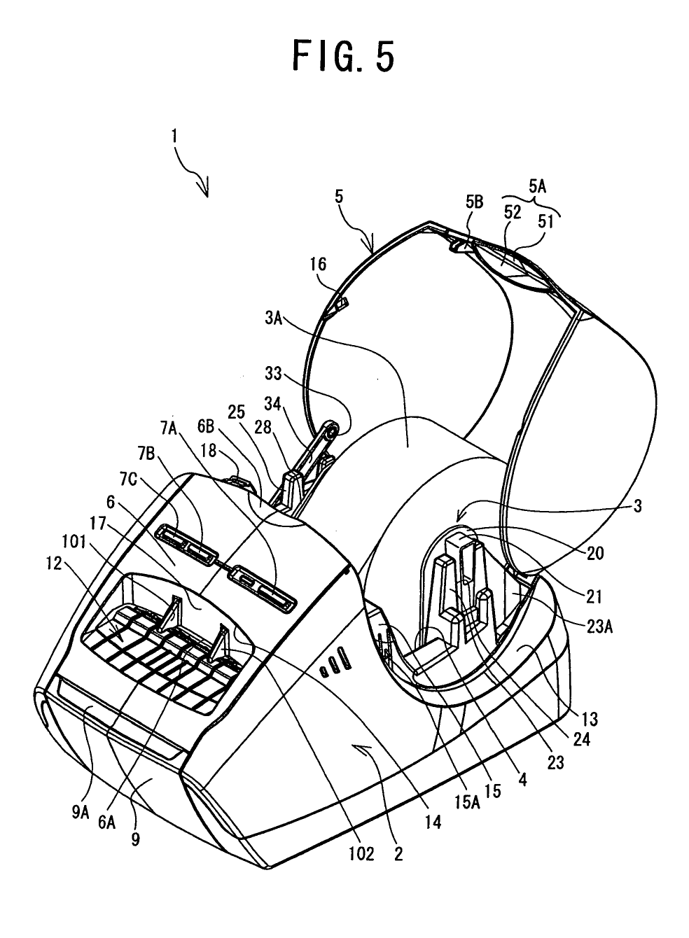

With reference to in FIGS. 1 to 3, the tape printing apparatus 1 includes a body case 2 formed of a resin. A roll sheet holder storage portion 4 (see FIG. 4) having a “U” shaped curve in the side view is provided in a rear upper portion of the body case 2. As shown in FIG. 5, a roll sheet holder 3 is attached to the roll sheet holder storage portion 4. The roll sheet holder 3 on which a roll sheet 3A having a predetermined width is wound and held. A top cover 5 having a substantially semicircular shape in the side view and formed of a transparent resin is attached to an upper end edge portion on the rear side of the body case 2. The top cover 5 is thus attached to be openable and closable (see FIGS. 1 and 4) and in such a manner as to cover the roll sheet holder storage portion 4.

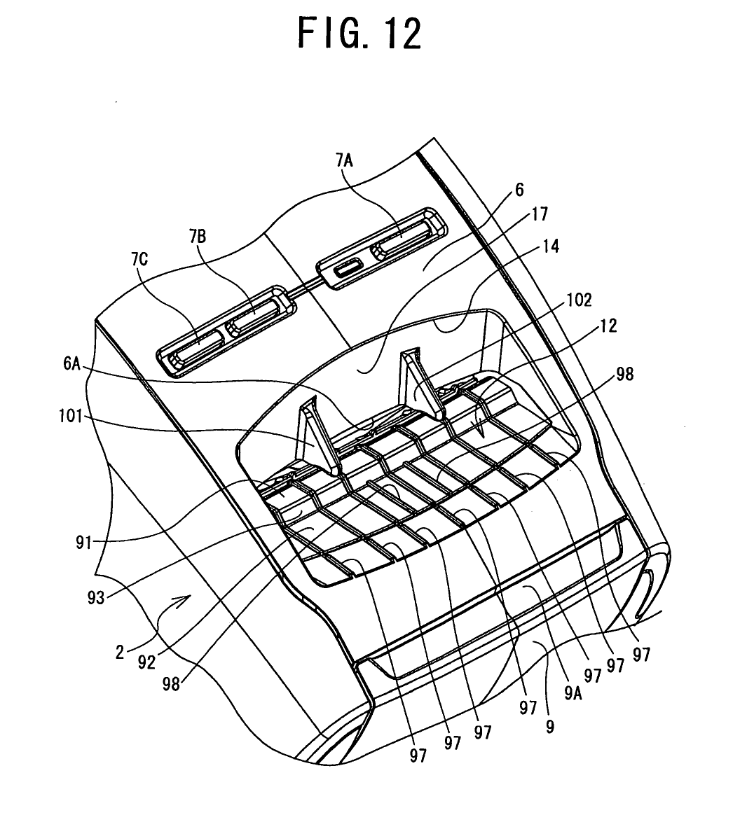

As shown in FIGS. 1 and 2, a resin front cover 6 for covering the front side of the body case 2 is provided on the front side of the top cover 5. An opening portion 14 having a substantially rectangular shape in the front view is provided in the center of the front cover 6. A sheet discharge port 6A for discharging the printed roll sheet 3A is provided substantially horizontally on a central depth of the opening portion 14. An inner wall 17 extending downward to the sheet discharge port 6A is provided in an upper edge portion of the opening portion 14. Holding ribs 101, 102 protruding frontward are provided on a front face opposing the outside of the inner wall 17. The holding ribs 101, 102 press the roll sheet 3A discharged from the sheet discharge port 6A from above, and are provided in the form of a pair of triangular plates in the side view. A stage 12 extending frontward is provided on the front side of the sheet discharge port 6A. The stage 12 is a resin plate including multiple ribs 97, 98 which will be described later (see FIG. 12), on an upper face thereof, and has a substantially rectangular shape in the plan view. According to this configuration, the roll sheet 3A discharged from the sheet discharge port 6A is pushed out onto the stage 12 while being held down from above by the holding ribs 101, 102 to thereby maintain its substantially horizontal state. A more detailed configuration of the stage 12 will be described below.

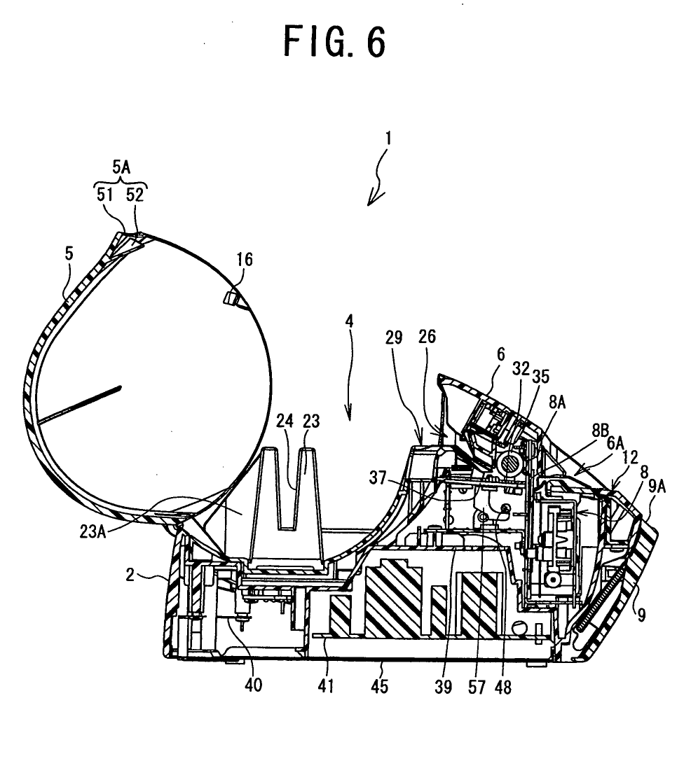

As shown in FIG. 1, a power button 7A, a cut button 7B, and a feed button 7C are disposed in a substantially horizontal alignment on an upper side of the opening portion 14. The cut button 7B causes driving of a after-mentioned cutter unit 8 (see FIG. 6) provided in the inner side of the sheet discharge port 6A, thereby to cut the roll sheet 3A. The feed button 7C causes discharging the roll sheet 3A along a sheet transfer direction.

As shown in FIGS. 1 and 2, a resin tray member 9 having a substantially rectangular shape in the front view is provided to be openable and closable on a front side of the front cover 6 and on a lower front side of the body case 2. A lower portion of the tray member 9 is axially supported in a lower front portion of the body case 2. A concave portion 9A is formed on an upper end edge portion of the tray member 9. A user can open the resin tray member 9 frontward by pivotally operating with a finger of the user placed on the concave portion 9A. Thereby, a cut piece of the roll sheet 3A discharged from the sheet discharge port 6A can be accumulated on the tray member 9. When a roll sheet 3A with a paper curling is discharged from the sheet discharge port 6A, the front side of the roll sheet 3A is bent downward. Hence, depending on the case, the leading end portion of the roll sheet 3A may enter between the front cover 6 and the tray member 9. However, since the concave portion 9A is provided in an upper end edge portion of the tray member 9 of the present embodiment, the upper end edge portion of the tray member 9 is somewhat lower than a lower end portion of the front cover 6. According to this configuration, the leading end portion of the roll sheet 3A is not caught in the upper edge portion of the tray member 9. Consequently, the roll sheet 3A is discharged smoothly.

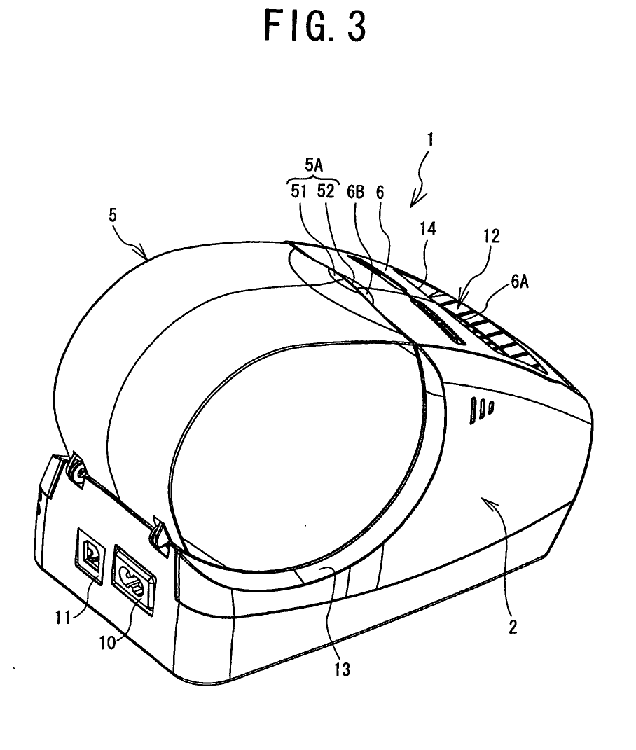

As shown in FIG. 3, an inlet 10 to be connected with a power cord (not shown) is provided in a back wall portion of the body case 2. A USB connector 11 (USB: Universal Serial Bus) to be connected with a personal computer etc. is provided adjacent to the inlet 10.

As shown in FIGS. 4 and 5, step portions 13, 13 gradually sloping downward to the outside are provided respectively in left and right lateral edge portions of the body case 2 against which open ends of the top cover 5 abut. Elastic engaging pieces 15, 15 formed to be inwardly elastically deformable are provided on front sides of left and right lateral wall portions of the roll sheet holder storage portion 4.

Engaging protrusions 15A, 15A each having a lateral-section triangular shape and outwardly protruding are formed, respectively, on outer faces of the elastic engaging pieces 15, 15. The engaging protrusions 15A, 15A, respectively, engage with engagement concave portions 16, 16 (which are respectively shown in FIGS. 4 and 5) formed on two edge portions on the opening side of the top cover 5. More specifically, the elastic engaging pieces 15, 15 engage with the respective engagement concave portions 16, 16 when the top cover 5 is pivotally moved to the front side direction and the engaging protrusions 15A, 15A contact with the step portions 13, 13. Hence, the top cover 5 is held in the closed state.

As shown in FIG. 1, a semispherical concave finger placing portion 5A for operation of opening/closing of the top cover 5 is provided in the center of the front edge portion of the top cover 5. The finger placing portion 5A includes an arcuate portion 51 and a wall portion 52. The arcuate portion 51 is formed by arcuating outwardly a central portion of the front edge portion of the top cover 5. The wall portion 52 opposes the inner face of the arcuate portion 51 and is arcuate towards an inner side opposite to the arcuate portion 51. The user can get his/her finger caught in an inner side of the finger placing portion 5A, thereby to cause the cover to move backward pivotally. Then, the engagement between the elastic engaging pieces 15, 15 and the engagement concave portions 16, 16 are released. In this manner, the user is able to easily open the top cover 5. A concave portion 6B which has a gradual downward curvature is formed in a central portion in the upper edge portion of the front cover 6 opposing the finger placing portion 5A. According to this configuration, since the user is able to easily snag his/her finger on the inner side of the finger placing portion 5A, thereby being able to easily open the top cover 5.

As shown in FIG. 2, in the state where the top cover 5 is closed, the portion between the arcuate portion 51 of the finger placing portion 5A and the upper edge portion of the front cover 6 is closed by the wall portion 52 of the finger placing portion 5A. According to this configuration, foreign matters can be prevented from invading into the inner side of the body case 2 from the inner side of the finger placing portion 5A. The wall portion 52, which closes the inner side of the finger placing portion 5A, is provided on the side of the top cover 5, not on the side of the front cover 6. According to this configuration, when the top cover 5 is opened in the event of attachment or detachment of the roll sheet holder 3, the wall portion 52 departs together with the top cover 5 from the front cover 6. Hence, the roll sheet holder 3 can be smoothly attached or detached from the roll sheet holder storage portion 4.

As shown in FIGS. 4 and 5, a push tab portion 5B is provided protrudingly on a front left side of the finger placing portion 5A. Further, a top cover detection switch 18 is provided on a predetermined position at the body case 2 that opposes the push tab portion 5B when the top cover 5 is closed. The top cover detection switch 18 determines whether the top cover 5 is closed. The top cover detection switch 18 includes a microswitch, for example. By detecting whether being depressed by the push tab portion 5B, the top cover detection switch 18 determines whether the top cover 5 is closed.

As shown in FIGS. 5 and 6, a columnar holder support member 23 for supporting the roll sheet holder 3 is provided in a right edge portion of the roll sheet holder storage portion 4. Further, in such a manner as to oppose the holder support member 23, a partition wall 25 is provided in a left edge portion of the roll sheet holder storage portion 4. The holder support member 23 includes a first positioning groove portion 24 formed to have a vertically long “U” shape opening upward in the side view. The configuration is formed such that a mounting member 21 is fitted into the first positioning groove portion 24. The mounting member 21 has a substantially rectangular shape in the cross-section view, is formed to the outer face of the positioning holding member 20, and constitutes the roll sheet holder 3 shown in FIG. 5.

As shown in FIGS. 5 and 6, a cover wall 23A is provided in a portion opposite to an axial support side of the top cover 5 of the holder support member 23. The cover wall 23A is thus provided to cover a clearance between the holder support member 23 and the axially support side of the top cover 5 as viewed from the right side plane of the tape printing apparatus 1. The cover wall 23A has a substantially triangular shape in the side view. Further, as shown in FIG. 4, a cover wall 25A is provided in a portion opposite to the axial support side of the top cover 5 of the partition wall 25. The cover wall 25A is thus provided to cover a clearance between the partition wall 25 and the axial support side of the top cover 5 as viewed from the left side plane of the tape printing apparatus 1. The cover wall 25A also has a substantially triangular shape in the side view. With the cover walls 23A and 25A, foreign matters such as dust can be prevented from invading into the roll sheet holder storage portion 4 from the outside through the clearances formed between the axial support side of the top cover 5 and the holder support member 23 and the partition wall 25.

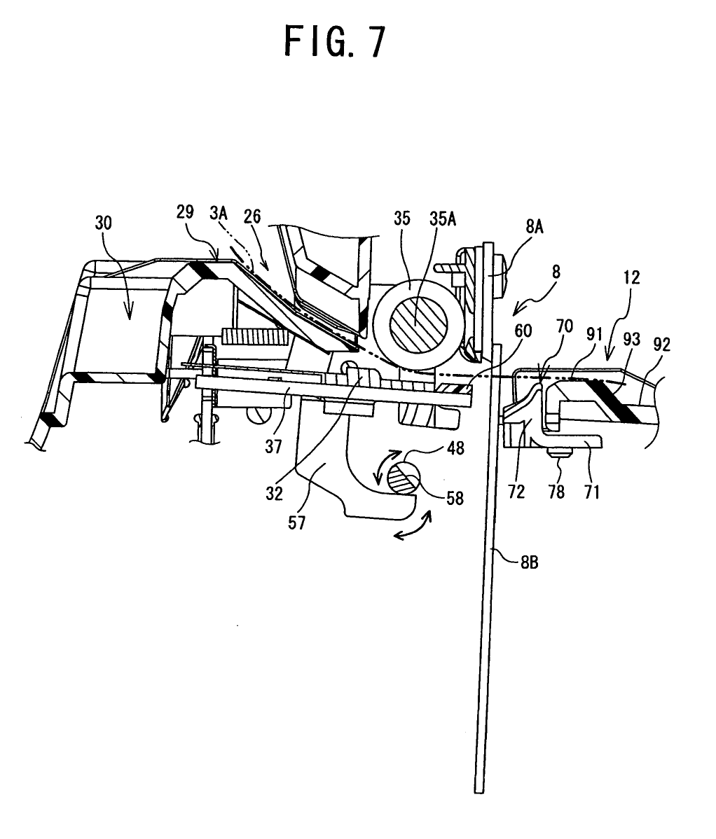

As shown in FIGS. 6 and 7, a mount portion 29 substantially horizontally extends frontward from the front-side upper end edge portion of the roll sheet holder storage portion 4. A loading port 26 for loading the roll sheet 3A is provided on the upper side of the front edge portion of the mount portion 29. Five second positioning groove portions 30 (one of which is shown in FIG. 7) are respectively provided in the width direction of the mount portion 29 in an end edge corner portion on a transfer direction rear side of the mount portion 29. Each second positioning groove portion 30 has a substantially “L” shape in cross section view, and corresponds to respective width dimensions of plural roll sheets. A leading-end lower end portion abutting on the mount portion 29 of a guide member 28 (see FIG. 5) that constitutes the roll sheet holder 3 is inserted from above. In the configuration thus formed, the roll sheet holder 3 is positioned and mounted in the inner side of the roll sheet holder storage portion 4.

As shown in FIG. 5, an engagement shaft 33 is protrudingly provided in the inner side of the periphery of an opening portion of the top cover 5 and in a position opposing a lateral edge portion on the side opposite to the holder support member 23 of the roll sheet holder storage portion 4. One end portion in the longitudinal direction of a lengthy link lever 34 supporting the top cover 5 is pivotably and removably mounted to the engagement shaft 33. The other end portion of the link lever 34 is coupled to a pivotal mechanism that vertically moves a thermal head 32 (described below) via multiple gears. According to this configuration, the thermal head 32 reciprocates between standby state and press contact state in response to opening and closing of the top cover 5. The thermal head 32 moves apart from the platen roller 35 in the standby state, but press contacts with the platen roller 35 in the press contact state.

An interior mechanism of the body case 2 will now be described hereinbelow. As shown in FIGS. 6 and 7, a sheet transfer path transferring the roll sheet 3A from the loading port 26 to the sheet discharge port 6A is provided. A pivotal shaft 35A of the platen roller 35, which works as a transfer mechanism, is rotatably provided above the sheet transfer path. Further, the thermal head 32 is supported to be contactable with and detachable from the platen roller 35 under the sheet transfer path and in a position opposing the platen roller 35. A radiator plate 37 made of metal is fixed to a lower face of the thermal head 32

The radiator plate 37 is supported pivotably. Hence, the thermal head 32 is contactable with and detachable from the platen roller 35. The radiator plate 37 is always urged by a compression spring (not shown) so that the thermal head 32 is pressed to the platen roller 35. A lower interference member 57 having a substantially “L” shape in the side view is provided under the radiator plate 37. A leading end of the lower interference member 57 is in contact with one end portion of a release shaft 48 which rotates in operative association with the pivotal movement of the link lever 34 (see FIG. 4) operatively connected to the top cover 5. One end portion of the release shaft 48 is formed in so-called “D-cutting” so that the shape of the end portion as viewed from the axial direction is a “D” shape. Hence, the one end portion is formed with a cut-out face 58 cut out parallel to the axial direction. A resin guide member 60 for guiding the printed roll sheet 3A to the cutter unit 8 is fixed to an upper face on the side of a leading end of the radiator plate 37.

In this structure, when the link lever 34 moves pivotally upon opening/closing of the top cover 5, the release shaft 48 rotates via the pivotal mechanism including the multiple gears (not shown). For instance, when the top cover 5 is opened, the leading end of the lower interference member 57 is urged downward by an outer circumferential surface of one end portion of the release shaft 48. Then, the lower interference member 57 rotates clockwise in the left side view, the thermal head 32 departs from the platen roller 35. Conversely, when the top cover 5 is closed, the leading end of the lower interference member 57 is positioned against the cut-out face 58 of the one end portion of the release shaft 48, and thus the leading end of the lower interference member 57 is not urged downward. Hence, the lower interference member 57 pivots counterclockwise in the left side view via the radiator plate 37 in response to the urging of the compression spring (not shown). In this case, since the thermal head 32 is pressed to the platen roller 35, it enters a print-ready state. The print medium is transferred in the state where the platen roller 35 is pressed to the thermal head 32, so that a transfer mechanism does not have to be additionally provided. Consequently, the configuration in the case can be simplified.

As shown in FIGS. 6 and 7, the cutter unit 8 is provided on the downstream side of the thermal head 32. The cutter unit 8 includes a stationary blade 8A, a movable blade 8B, and a cutting motor (not shown). The stationary blade 8A is disposed above the sheet transfer path. The movable blade 8B opposes the stationary blade 8A, has a “V” shape in the front view, and is disposed under the sheet transfer path. The cutting motor is configured by a DC motor and operates to move the movable blade 8B. When the cut button 7B is depressed, the cutting motor drives the movable blade 8B to reciprocatingly move it in the vertical direction. Thereby, the roll sheet 3A is cut off between the stationary blade 8A and the movable blade 8B. Then, a cut piece of the roll sheet 3A is discharged from the sheet discharge port 6A.

As shown in FIG. 7, a tray base 70 is provided between the cutter unit 8 and the stage 12. The tray base 70 has a substantially “L” shape (in the side view) extending along the width direction of the sheet discharge port 6A. The tray base 70 is a resin member that operates to gently move up a leading end portion of the cut piece of the roll sheet 3A cut off by the cutter unit 8 and then to smoothly push out the cut piece onto the stage 12. A more detailed configuration of the tray base 70 will be described below.

As shown in FIG. 6, a control board 40 is provided via a partition wall 39 under the roll sheet holder storage portion 4. The control board 40 includes, for example, a control circuit that drives and controls respective mechanism portions, such as the thermal head 32, in accordance with instructions issued by an external personal computer or the like. A power supply board 41 including a power supply circuit formed therein is provided under a printing mechanism via the partition wall 39. The printing mechanism is configured to include, for example, the thermal head 32 and the platen roller 35. The thermal head 32 is connected to a connector (not shown) provided on the bottom face side of the control board 40 by way of a flexible flat cable (FFC) (not shown). The control board 40 and the power supply board 41 are covered by a bottom face cover 45 formed of a thin steel sheet and fixed with screws to a bottom face portion.

The roll sheet 3A which is used in the tape printing apparatus 1 of the present embodiment is, for example, a lengthy heat sensitive sheet (so-called “thermal paper”) having a self color development property, or a lengthy label sheet formed of the thermal sheet having one side on which a release sheet is bonded by an adhesive. The roll sheet 3A is held by being wound on the roll sheet holder 3 so that a print surface faces inward.

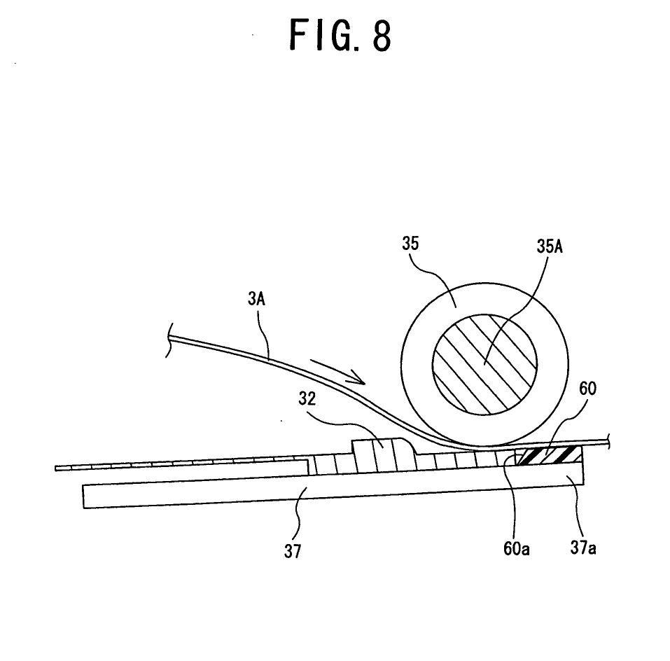

Next, a fixing structure of the guide member 60 will now be described hereinbelow with reference to FIG. 8. As described above, the radiator plate 37 is fixed to the lower face of the thermal head 32. An extended portion 37a extending to the downstream side in transfer direction of the roll sheet 3A is provided to the radiator plate 37. The resin guide member 60 is bonded and fixed to the upper face opposite to the platen roller 35 of the extended portion 37a.

A tapered portion 60a is formed at a corner portion of the guide member 60 opposite to the thermal head 32. The tapered portion 60a is thus provided to prevent the leading end portion of the roll sheet 3A from being caught or jammed. More specifically, the one end portion of the guide member 60 opposite to the thermal head 32 is adjusted to be lower than the height of the thermal head 32. According to this configuration, the roll sheet 3A can be prevented from a case where the leading end portion of the roll sheet 3A is caught by one end of the guide member 60 opposite to the thermal head 32, and the roll sheet 3A is thereby caused to be not transferable. The height of the other end of the guide member 60, which other end is opposite to the tapered portion 60a, is adjusted so that the roll sheet 3A is smoothly transferred to the cutting position of the cutter unit 8 when the thermal head 32 is pressed to the platen roller 35.

The guide member 60 as described above is fixed to the upper face of the extended portion 37a extending on the same plane as the upper face of the radiator plate 37 to which the thermal head 32 is fixed. Hence, an influence of variation due to the thickness of the radiator plate 37 is not imposed. According to this configuration, since the height of the guide member 60 can easily be adjusted to the thermal head 32, the correlative positional accuracy between the thermal head 32 and the guide member 60 is improved. In addition, since the thickness of the radiator plate 37 does not have to be taken into account, a mass-production of guide members 60 having the same height can be accomplished. Since the guide member 60 is made of a resin, there is no possibility of color development even when the print surface of the roll sheet 3A has contacted with the surface of the guide member 60 that has been damaged for some reason. Even when the roll sheet 3A contacts with the damaged guide member 60, the roll sheet 3A is not damaged. Further, since the guide member 60 is supported by the extended portion 37a, accidental dropping of the guide member 60 can be prevented. Since the radiator plate 37 includes the extended portion 37a, it supports the guide member 60, and it can have a large surface area, so that it is able to effectively perform heat radiation.

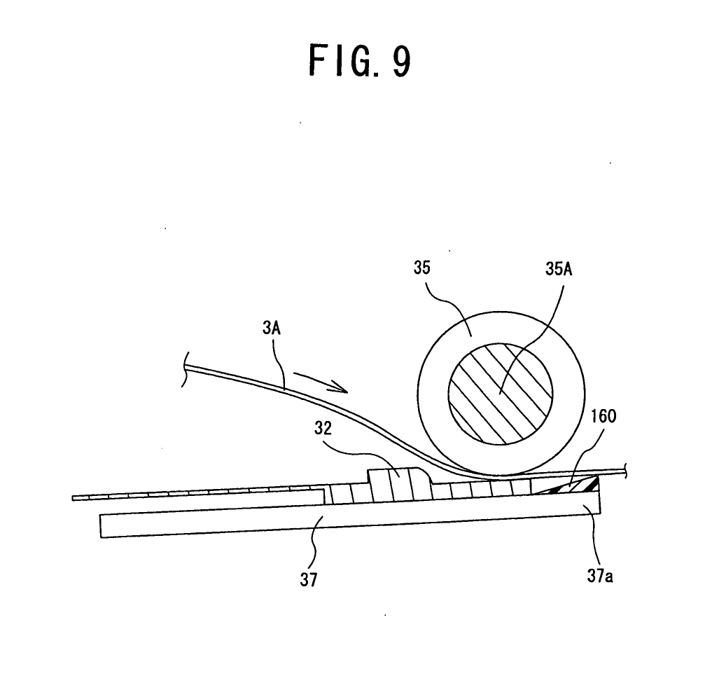

It is noted that, the shape of the guide member 60 is not limited to a shape shown in FIG. 8. According to the shown configuration, the tapered portion 60a is provided only in the corner portion of one end portion opposite to the thermal head 32. However, the configuration may be such that, as a modified example shown in FIG. 9, the entirety of a guide member 160 is formed into a tapered shape so as to be gradually higher toward the downstream side in transfer direction of the roll sheet 3A from the side of the thermal head 32. Ordinarily, a roll sheet is wound with a print surface facing inward, and is transferred with the print surface facing downward, so that the roll sheet is curled downward. As such, when the guide member 160 is configured as shown and described above, the leading end portion of the roll sheet is guided along the shape of the guide member. Hence, transfer failure of the roll sheet caused by being caught by the guide member can be prevented. Further, even in the case of a continuous fanfold label sheet without curling, transfer failure of the end face of a label caused by being caught by the guide member and separation of a label from the release sheet can be prevented.

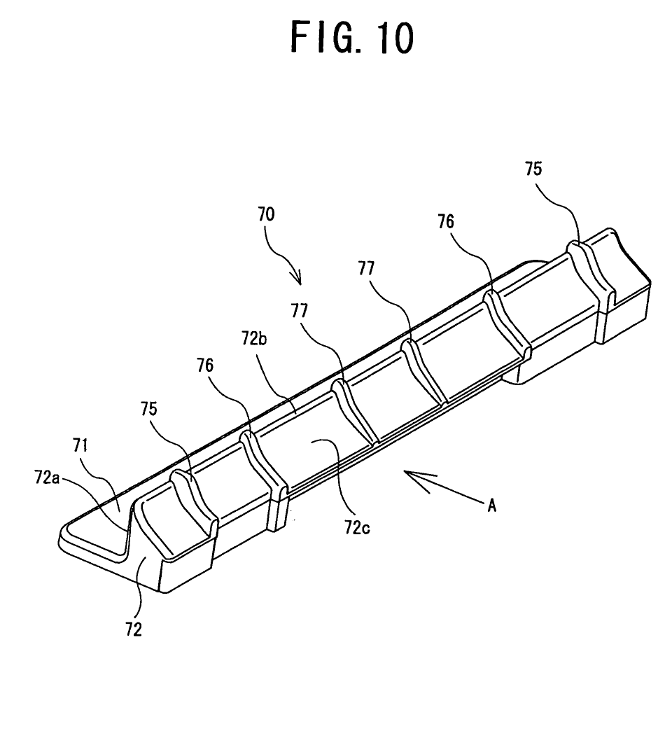

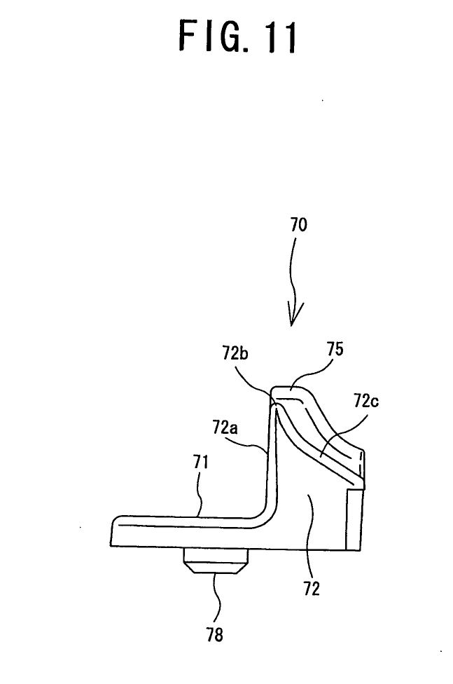

Next, the shape of the tray base 70 will be described hereinbelow with reference to FIGS. 10 and 11. As described above, the tray base 70 is the resin member formed into an “L” shape in the side view. The tray base 70 includes a base portion 71 and a guide wall portion 72. The base portion 71 has a laterally long, rectangular shape in the plan view, and extends parallel to the width direction of the sheet discharge port 6A (see FIGS. 1 and 2). The guide wall portion 72 has a substantially rectangular shape in the side view, and is formed in a width-direction one end portion (one end portion on the upstream side in a transfer direction A shown in FIG. 10) of the base portion 71. In a lower portion of the base portion 71, a protrusion 78 (see FIG. 11) is formed to protrude downward. The protrusion 78 (see FIG. 11) is for insertion into a mounting hole (not shown) of a support member (not shown) provided in the interior of the body case 2. Further, the guide wall portion 72 includes a vertical face 72a and a slope face 72c. The vertical face 72a is opposite to the side of the base portion 71. The slope face 72c is gently sloped from a vertex portion 72b of the vertical face 72a towards the upstream side in the transfer direction A.

The slope face 72c is formed along the width direction of the tray base 70. Ribs 75, 75 extending towards the upstream side in the transfer direction A along the slope face 72c from the vertex portion 72b are, respectively, provided on both width-direction end sides of the slope face 72c. Ribs 76, 76 are, respectively, provided in the inner side interposed between the ribs 75, 75. Ribs 77, 77 are, respectively, provided in the inner side interposed between the ribs 76, 76.

As shown in FIG. 11, as compared with the other ribs 76 and 77, an upper side of the respective rib 75 extends substantially horizontally towards the side of the cutter unit 8 (see FIG. 7). According to this configuration, the roll sheet 3A cut by the cutter unit 8 and pushed out is supported by the substantially horizontally extending portions of the ribs 75, 75. According to the configuration, the cut roll sheet 3A can be prevented from dropping between the tray base 70 and the cutter unit 8. Then, when a subsequent roll sheet 3A is fed, the previous roll sheet 3A is pushed out frontward, so that the roll sheet 3A is normally discharged from the sheet discharge port 6A.

Next, the shape of the stage 12 will be described herebelow with reference to FIGS. 7 and 12 to 14.

As shown in FIGS. 7 and 12, the stage 12 is provided along the width direction of the sheet discharge port 6A, and is formed in a step shape in the side view towards the downstream side in transfer direction from the tray base 70. The stage 12 includes a first stage portion 91, a second stage portion 92, and a step portion 93. The first stage portion 91 has a laterally long, rectangular shape in the plan view having a substantially same height as the vertex portion 72b (see FIGS. 10 and 11) of the tray base 70. The second stage portion 92 is provided on the front side of the first stage portion 91, and has a rectangular shape in the plan view that is one step lower than the first stage portion 91. The step portion 93 is provided between the first stage portion 91 and the second stage portion 92, and has a laterally long, rectangular shape in the plan view that is sloped towards the second stage portion 92 from the first stage portion 91.

As shown in FIG. 12, multiple ribs are respectively provided on the upper face of the stage 12 along the transfer direction of the roll sheet 3A. More specifically, seven ribs 97 are formed in alignment along the width direction of the stage 12, and are formed to extend the respective upper faces of the first stage portion 91, the step portion 93, and the second stage portion 92. Auxiliary ribs 98, 98 are, respectively, formed on both left and right sides of a central rib 97 of the seven ribs 97. The auxiliary ribs 98, 98 each have a length of a substantially one half of that of the second stage portion 92 in the forward-rearward direction, and are formed to extend parallel to the ribs 97.

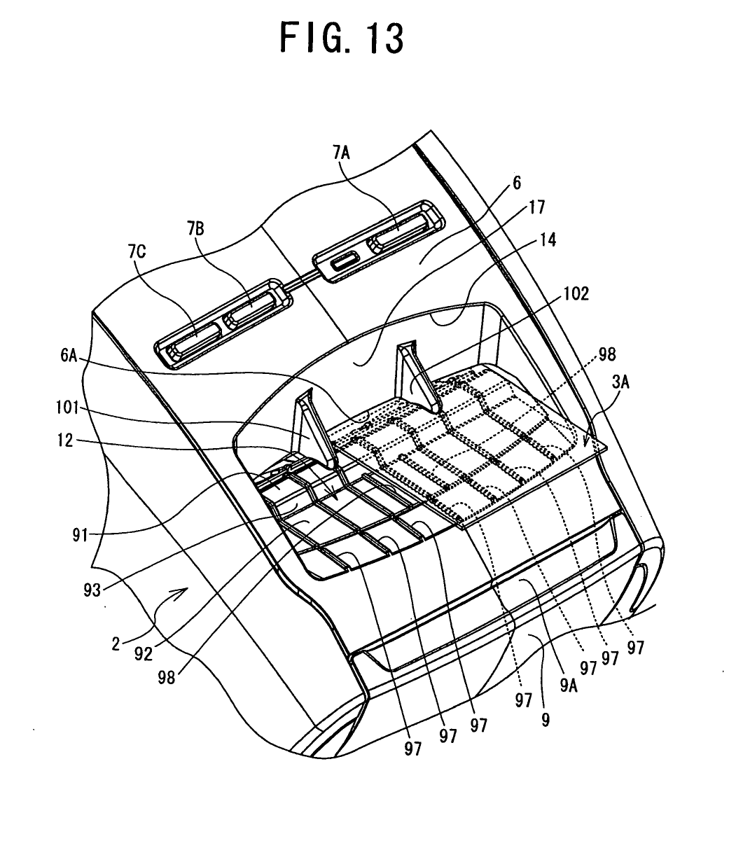

For example, as shown in FIG. 13, a roll sheet 3A cut by the cutter unit 8 into a predetermined width is pushed out onto the stage 12 from the sheet discharge port 6A. Here, a cut end of the roll sheet 3A has the adhesive remaining thereon, the cut end is in a state where it is likely to adhere onto a peripheral portion. However, in the operation, the respective upper portions of four ribs 97 contact with the lower face of the roll sheet 3A on the stage 12. Hence, the cut end of the roll sheet 3A does not contact directly with the upper face of the stage 12, the roll sheet 3A can smoothly pushed out.

When the roll sheet 3A is exposed for a long period of time, a case can take place in which the cut end of the roll sheet 3A absorbs moisture in the atmosphere, thereby becoming wavy or in a wavy state. When a roll sheet 3A having a wavy cut end is transferred, the roll sheet 3A is transferred over the stage 12 in a state where the cut end thereof is wavy in the vertical direction, as compared with an ordinarily case. In this case, there can take a case in which the cut end enters into a clearance between the ribs 97, and contacts with the upper face of the stage 12, thereby transfer failure occurs. However, on the stage 12 the first stage portion 91, which is located on the side of the cutter unit 8, is one step higher than the second stage portion 92. Further, holding ribs 101 and 102 are provided on an upper side of the first stage portion 91. More specifically, the roll sheet 3A pushed out onto the first stage portion 91 is supported by the ribs 97, 97 from below, and simultaneously, is held down by the holding rib 101 from above. According to this configuration, the cut end of the roll sheet 3A is corrected to be substantially horizontal. Hence, on the second stage portion 92, since the cut end of the roll sheet 3A does not directly contact with the upper face, the roll sheet 3A can be prevented from being not transferable.

Further, the roll sheet holder 3, which is mounted in the roll sheet holder storage portion 4, holds roll sheets having various sheet widths. Depending upon the width of the roll sheet, there is a change in the position of one width-direction end portion of a roll sheet to be discharged from the sheet discharge port 6A (more specifically, one end portion in the direction of departure from the holder support member 23 including the first positioning groove portion 24 shown in FIG. 5). For example, as shown in FIG. 13, when a roll sheet 3A has been discharged from the sheet discharge port 6A, one width-direction end portion of the roll sheet 3A is positioned over the fourth rib 97 from the side of the holder support member 23. In this case, the one width-direction end portion of the roll sheet 3A rides over the fourth rib 97 from the side of the holder support member 23. Hence, even in the case that one width-direction end portion of the roll sheet 3A is downwardly curled, the one width-direction end portion of the roll sheet 3A does not contact with the upper face of the stage 12.

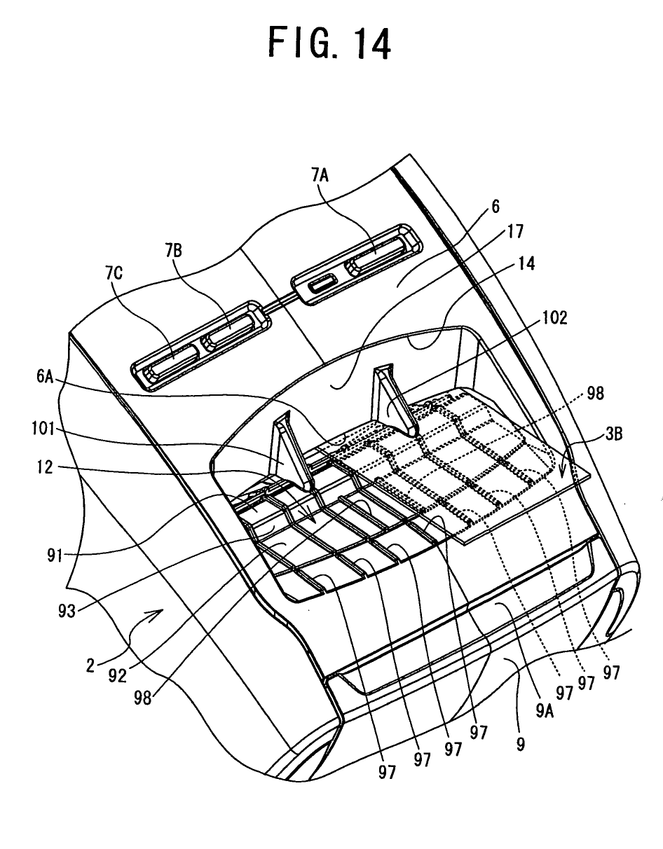

As shown in FIG. 14, an event is now considered in which the roll sheet 3B, which is different from the roll sheet 3A, has been discharged from the sheet discharge port 6A. In this event, one width-direction end portion of the roll sheet 3B (more specifically, one end portion in the direction of departure from the holder support member 23 including the first positioning groove portion 24 shown in FIG. 5) is positioned between the ribs 97, 97. However, the auxiliary ribs 98 exist between the ribs 97, 97. As such, the one width-direction end portion of the roll sheet 3B rides over the auxiliary ribs 98. Hence, even in the event that the one width-direction end portion of the roll sheet 3B is downwardly curled, the one width-direction end portion does not contact with the upper face of the stage 12. As described above, by arranging the respective auxiliary ribs 98 between the mutually adjacent ribs 97 taking into account the widths of roll sheets to be stored into the roll sheet holder storage portion 4, the cut end of the roll sheet can be prevented from contacting with the upper face of the stage 12. It is noted that, the positions and numbers of the ribs 97 and 98, for example, can be determined in accordance with the position of the second positioning groove portions 30 provided in the mount portion 29 shown in FIG. 7.

As described above, in the tape printing apparatus 1 of the present embodiment, the radiator plate 37 is fixed to the lower face of the thermal head 32. The extended portion 37a extending towards the downstream side in transfer direction of the roll sheet 3A is provided to the radiator plate 37. The resin guide member 60 is fixed with the adhesive onto the upper face of the extended portion 37a. More specifically, the guide member 60 is fixed to the upper face of the extended portion 37a on the same plane as the upper face of the radiator plate 37. Hence, the influence of variation due to the thickness of the radiator plate 37 is not imposed. According to this configuration, since the height of the guide member 60 can easily be adjusted to the thermal head 32, the correlative positional accuracy between the thermal head 32 and the guide member 60 is improved. As such, since the thickness of the radiator plate 37 does not have to be taken into account, a mass-production of guide members 60 having the same height can be accomplished. Further, since the guide member 60 is made of resin softer than metal, there is no possibility of, for example, damage to the print surface of the roll sheet 3A or color development caused on the roll sheet 3A even when the guide member 60 is damaged due to a certain cause and the print surface of the roll sheet 3A has contacted with the surface of the guide member 60.

It is noted that the present disclosure is not limited to the embodiment described above, but various improvements and modifications may be made without departing from the spirit and scope of the disclosure.

For example, as the roll sheet 3A, a thermal copying paper may be used instead of the thermal paper. The thermal copying paper is a medium of the type formed such that a transfer ink is coated on the reverse side of a thermal paper and a medium which is not a thermal paper is provided on the side of the coated surface, whereby printing on the thermal paper and the transfer of the ink are performed simultaneously at the time of printing.

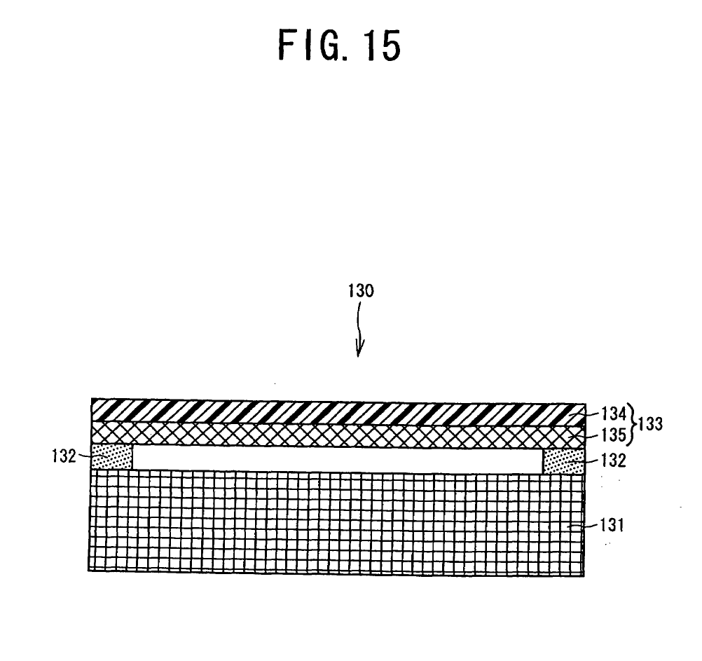

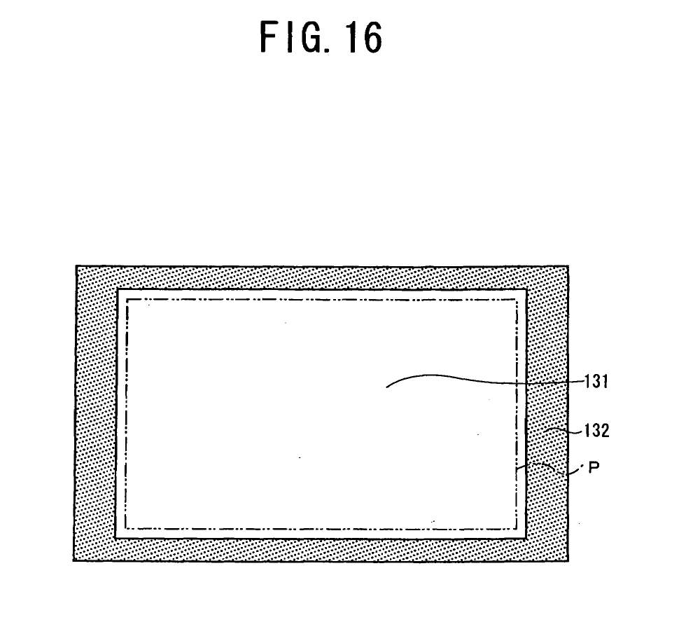

Further, a thermal transfer medium to be printed may be used by bonding an ink ribbon, such as disclosed in U.S. Pat. No. 6,309,498, onto a print medium may be used. For example, a thermal transfer label 130 shown in FIG. 15 is configured from a base material 131 as a print medium and an ink ribbon 133 bonded onto the side of a print surface thereof via an adhesive layer 132. As shown in FIG. 16, the adhesive layer 132 is provided in a portion other than a print range P of the print surface of the base material 131. The ink ribbon 133 is formed in such a manner that an ink layer 135 is provided on a reverse face of a film 134, and a surface on the side of the ink layer 135 is releasably bonded to the side of the print surface of the base material 131. The thermal transfer label 130 of this type is used in such a manner that the ink ribbon 133 is released from the base material 131 after printing. Depending upon the type of ink of the ink layer 135, the ink can be transferred not only by heat but also by pressure. In the case where the thermal transfer label is used, the ink layer 135 is not transferred onto the base material 131 even when the print medium contacts with the guide member 60 with damage, if any, since the guide member 60 is formed of a resin.

Further, the thermal transfer medium may not be a fixed-length label, but may be an undefined length roll sheet.

The printing apparatus according to the present disclosure is adaptable to a printing apparatus capable of printing on a print medium.

What is claimed is:

1. A printing apparatus comprising:
a case that stores a print medium transferred in the case;
a platen roller;
a thermal head pressed to the platen roller;
a radiation member made of a metal and provided on a surface of the thermal head on a reverse face of a pressed face opposing the platen roller;
an extended portion provided in the radiation member and extended further than the thermal head in a transfer direction of the print medium; and
a guide member made of a resin to guide the print medium printed by the thermal head, provided on a surface of the extended portion opposing the platen roller.

2. The printing apparatus according to claim 1, wherein
a corner portion of the guide member, which is opposing the thermal head and positioned on a downstream side in the transfer direction of the print medium, is tapered.

3. The printing apparatus according to claim 2, wherein
the platen roller transfers the print medium in a state where the platen roller is pressed to the thermal head.

4. The printing apparatus according to claim 3, wherein
the print medium is a roll sheet wound with a print surface facing inward.

5. The printing apparatus according to claim 4, wherein
the print medium is a thermal paper.

6. The printing apparatus according to claim 3, wherein
the print medium is a thermal paper.

7. The printing apparatus according to claim 2, wherein
the print medium is a roll sheet wound with a print surface facing inward.

8. The printing apparatus according to claim 7, wherein
the print medium is a thermal paper.

9. The printing apparatus according to claim 2, wherein
the print medium is a thermal paper.

10. The printing apparatus according to claim 1, wherein
the guide member positioned on a downstream side in the transfer direction of the print medium is higher towards the downstream side in the transfer direction.

11. The printing apparatus according to claim 10, wherein
the platen roller transfers the print medium in a state where the platen roller is pressed to the thermal head.

12. The printing apparatus according to claim 10, wherein
the print medium is a roll sheet wound with a print surface facing inward.

13. The printing apparatus according to claim 10, wherein
the print medium is a thermal paper.

14. The printing apparatus according to claim 1, wherein
the platen roller transfers the print medium in a state where the platen roller is pressed to the thermal head.

15. The printing apparatus according to claim 14, wherein
the print medium is a roll sheet wound with a print surface facing inward.

16. The printing apparatus according to claim 15, wherein
the print medium is a thermal paper.

17. The printing apparatus according to claim 14, wherein
the print medium is a thermal paper.

18. The printing apparatus according to claim 1, wherein
the print medium is a roll sheet wound with a print surface facing inward.

19. The printing apparatus according to claim 18, wherein
the print medium is a thermal paper.

20. The printing apparatus according to claim 1, wherein
the print medium is a thermal paper.
